(19) United States
(12) Patent Application Publication
(10) Pub. No.: US 2014/0016331 A1
(43) Pub. Date: Jan. 16, 2014

(54) MULTI-FUNCTION UNIVERSAL SERIAL BUS WEIGHT BEARING PLATFORM DEVICE

(71) Applicant: Shao-Chieh TING, New Taipei City (TW)

(72) Inventor: Shao-Chieh TING, New Taipei City (TW)

(21) Appl. No.: 13/545,771

(22) Filed: Jul. 10, 2012

(51) Int. Cl. F21V 21/002

(52) U.S. Cl. 362/382

(57) ABSTRACT

The present invention relates to a platform provided with an USB (Universal Serial Bus) hub and an USB power source. The USB hub on the platform enables connecting communication devices such as a computer mouse, and the like; while the USB power source on the platform enables connecting electric appliance products which use an USB as the power source connection. Moreover, the present invention enables charging cell phones, tablet computers, bluetooth earphones, and flashlights, as well as stable use of an USB camera.

### BACKGROUND OF THE INVENTION

(a) Field of the Invention

The present invention relates to a device provided with the double functions of an USB (Universal Serial Bus) hub and an USB power source. and more particularly to achieving the objective of providing the multiple functions of an USB hub and an USB power source through use of a plurality of USB input ports and a plurality of USB output ports installed on a circuit board.

(b) Description of the Prior Art

Along with the rapid development in the electronic communication industry, there has been continuous advancement in various types of electronic communication products, with product design being oriented toward diversification and providing multiple functions. An increasing number of electronic products and small electric appliances have adopted the USB (Universal Serial Bus) to replace the traditional AC (alternating current) input as the means to input power.

Because the number of USB ports installed on desktop computers and notebook computers is limited, thus, the needs of users cannot be met. Moreover, the relatively light weight of USB hubs and USB power sources in the current market causes electric appliances, such as a desk lamp or fan, to easily fall over when connected.

Hence, in light of the shortcomings derived from the aforementioned prior art, and the urgent need for improvement, after many years of painstaking efforts and meticulous study and exploration, the inventor of the present invention finally successfully developed the present invention.

### SUMMARY OF THE INVENTION

The primary objective of the present invention lies in providing a device having the multiple functions of serving as an USB (Universal Serial Bus) hub and an USB power source, in which a plurality of USB ports are installed on a circuit board. thereby enabling the use of many kinds of products having an USB as the input medium.

A further objective of the present invention lies in disposing a balance weight in the interior of the device to support the weight of a particular load.

Another objective of the present invention lies in providing the device with a hollow, which enables the user to place tiny office supplies such as memo pads, and the like, therein.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational schematic view depicting a multi-function USB weight bearing platform of the present invention.

FIG. 2 is another elevational schematic view depicting the multi-function USB weight bearing platform of the present invention.

FIG. 3 is an exploded elevational schematic view depicting the multi-function USB weight bearing platform of the present invention.

FIG. 4 is an elevational schematic view depicting the multi-function USB weight bearing platform with USB (Universal Serial Bus) port cover plates covering the USB ports according to the present invention.

FIG. 5 is an elevational cutaway view depicting the multi-function USB weight bearing platform of the present invention.

FIG. 5A is a partial enlarged schematic view of FIG. 5.

FIG. 6 is a planar view depicting packaging of the multi-function USB weight bearing platform of the present invention.

### DETAILED DESCRIPTION OF THE PREFERRED EMBODIMENTS

Regarding the detailed content and structural means of the present invention, please refer to the description of the diagrams as follows:

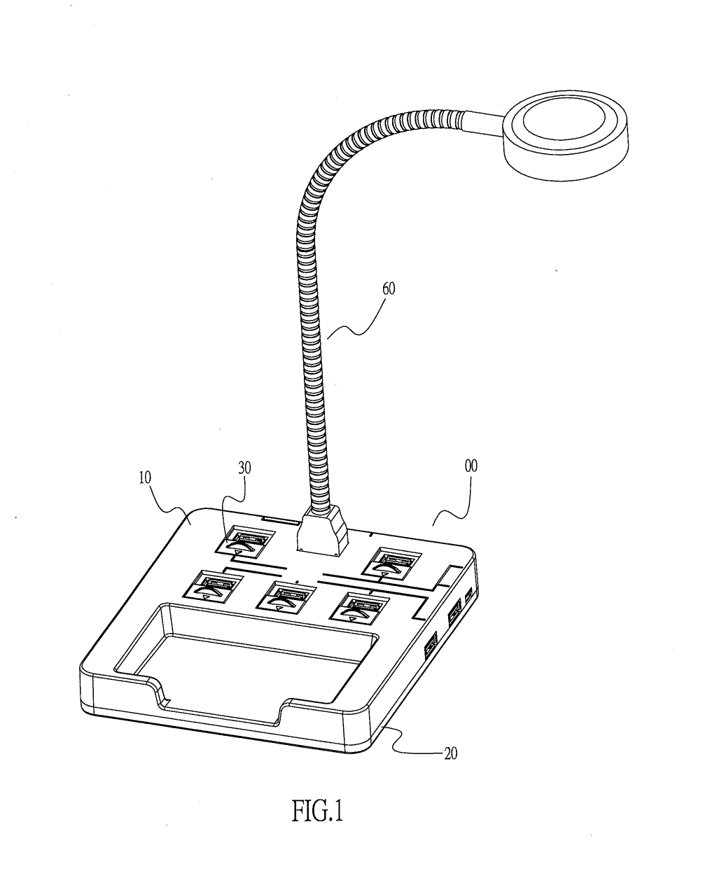

Referring first to FIG. 1, which shows an elevational schematic view depicting a multi-function USB (Universal Serial Bus) weight bearing platform of the present invention, wherein a weight bearing platform 00 of the present invention comprises an upper cover 10, a lower cover 20, a plurality of USB port cover plates 30 and a USB power source LED (Light Emitting Diode) desk lamp 60.

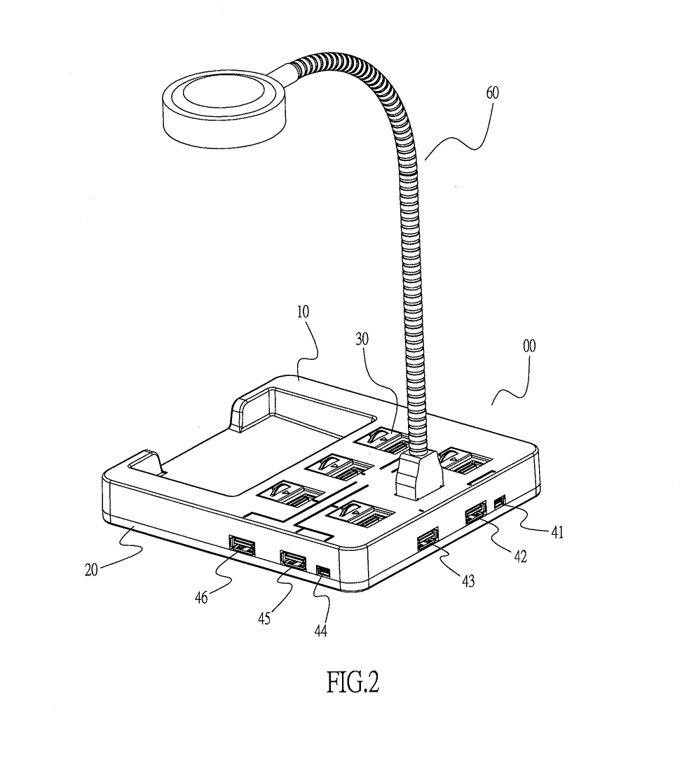

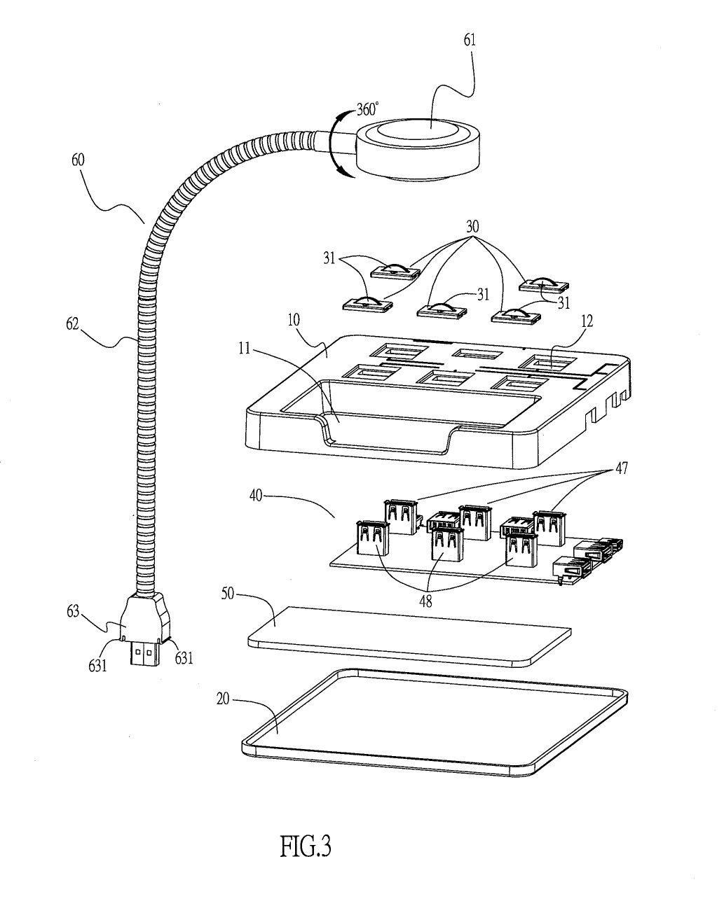

Referring to FIG. 2 and FIG.3, which show another elevational schematic view and an exploded elevational schematic view respectively of the multi-function USB weight bearing platform of the present invention, wherein the upper cover 10 is used to cover the top surface of a circuit board. The upper cover 10 is provided with a hollow, which enables the user to place tiny office supplies such as memo pads, and the like, therein. The upper cover 10 is provided with a plurality of USB port apertures 12. The lower cover 20 is used to cover the bottom surface of the circuit board.

The USB port cover plates 30 are installed on the upper cover 10 and used to cover the top portions of the USB ports to prevent foreign substances from entering and damaging the ports. The upper portion of each of the USB port cover plates 30 is fitted with a lifting strip 31 for the convenience of the user in sliding the USB port cover plates 30.

A circuit board module 40 is the core of the weight bearing platform 00 of the present invention. The circuit board module 40 is fitted with a Mini USB power source input port 41, a USB power source input port 42, a USB hub input port 43, a Mini USB power source output port 44, a USB power source output port 45, a USB hub output port 46, a plurality of USB power source output ports 47, and a plurality of USB hub output ports 48.

A balance weight 50 is disposed between the upper cover 10 and the lower cover 20 and is used to increase the weight of the weight bearing platform 00 for the purpose of supporting an electric appliance of certain weight and preventing it from falling over.

The USB power source LED desk lamp 60 comprises a 360 degree rotatable desk lamp head 61, a freely bendable snake tube 62 and a USB connector 63. A socket clasp 631 is configured on each of the two sides of the USB connector 63 to enable the USB connector 63 to stand stably on the main body of the weight bearing platform 00.

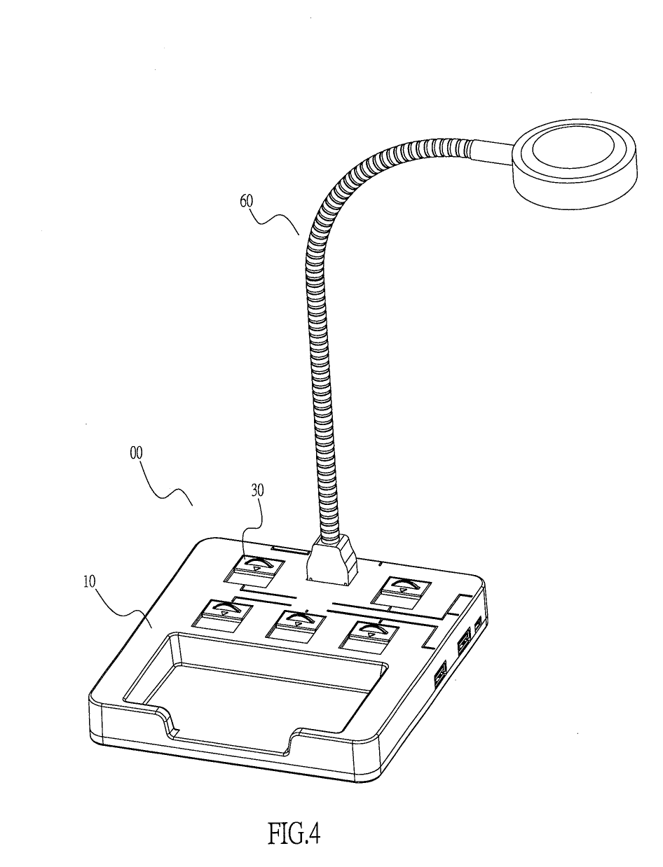

Referring to FIG. 4. which shows an elevational schematic view depicting the USB port cover plates 30 of the multi-function USB weight bearing platform 00 of the present invention covering the USB ports. thereby enabling preventing foreign substances such as dust, and the like, from entering the USB ports.

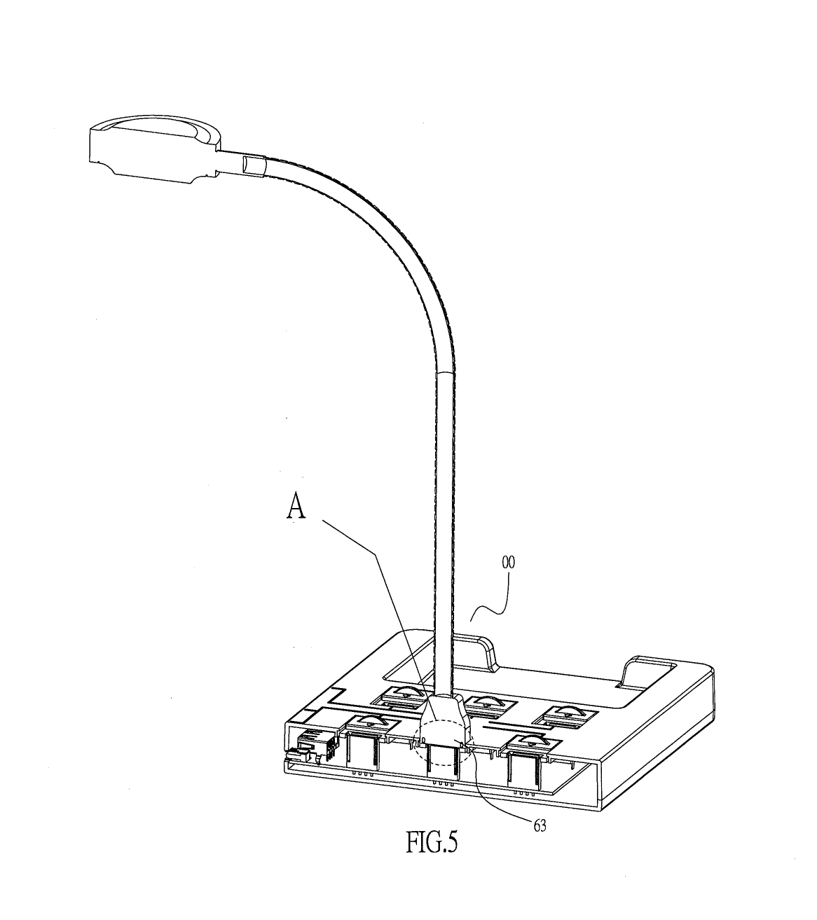

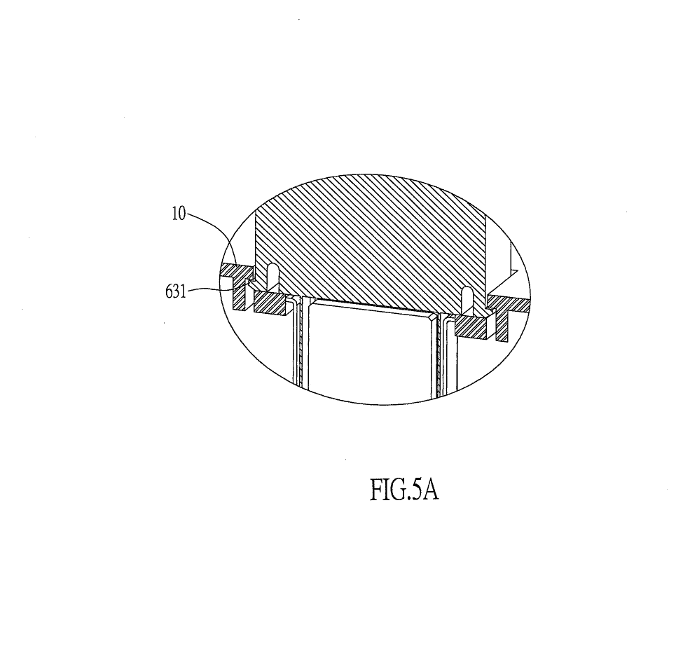

Referring to FIG. 5 and FIG. 5A, which show an elevational cutaway view and a partial enlarged schematic view respectively of the multi-function USB weight bearing platform 00 of the present invention. The drawings depict the clasping structure between the socket clasps 631 configured on the USB connector 63 of the USB power source LED desk lamp and the upper cover 10. Such a configuration provides additional stability to the desk lamp 60 disposedly positioned on the main body of the weight bearing platform 00.

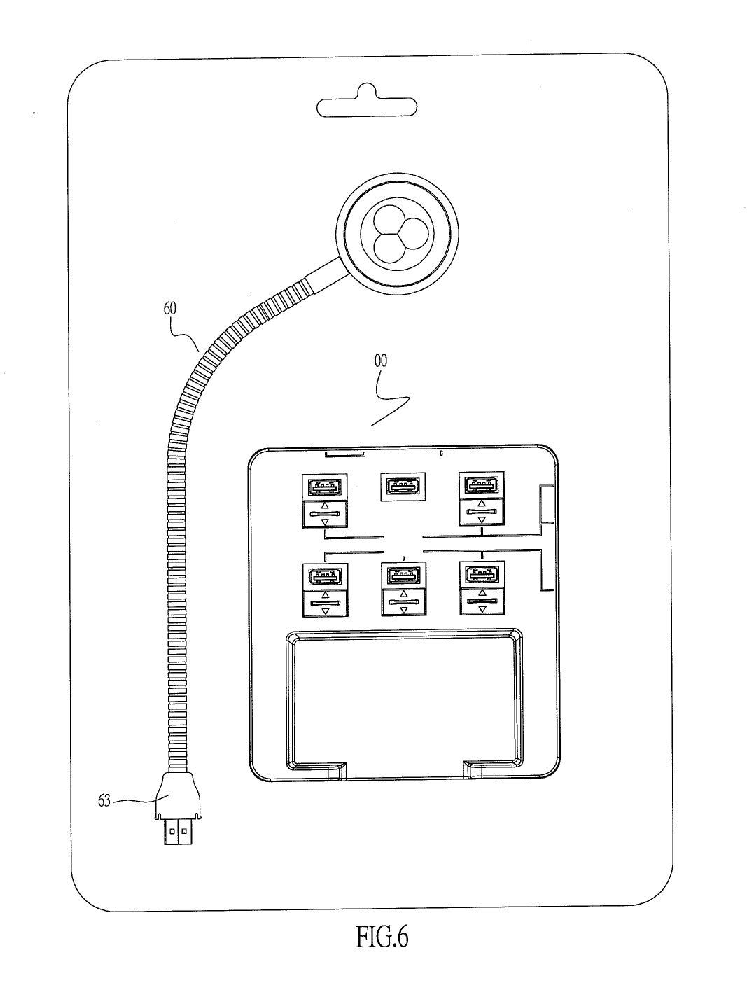

Referring to FIG. 6. which shows a schematic planar view depicting packaging of the multi-function USB weight bearing platform 00 of the present invention. The plane of the lamp head 61 of the USB power source LED desk lamp 60 is arranged to lie in the same plane as the USB connector 63. thereby facilitating packaging of the product.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multi-function Universal Serial Bus weight bearing platform device, comprising:
an upper cover and a lower cover, the upper cover and the lower cover are used to cover a circuit board module and a balance weight;
the circuit board module, the circuit board module is covered by the upper cover and the lower cover, and the circuit board module is fitted with many types of input ports and output ports;
a plurality of USB (Universal Serial Bus) port cover plates installed on the upper cover;
the balance weight, the balance weight is disposed between the upper cover and the lower cover;
an USB power source LED (Light Emitting Diode) desk lamp.

2. The multi-function Universal Serial Bus weight bearing platform device according to claim 1, wherein the balance weight is able to support a weight of small electric appliances.

3. The multi-function Universal Serial Bus weight bearing platform device according to claim 1, wherein the upper cover is provided with a hollow.

4. The multi-function Universal Serial Bus weight bearing platform device according to claim 1, wherein two sides of a USB connector of the USB power source LED desk lamp are respectively provided with a clasp.
